(19) United States
(12) Patent Application Publication
(10) Pub. No.: US 2024/0322642 A1
(43) Pub. Date: Sep. 26, 2024

(54) DRIVE DEVICE, PRESSURE GENERATOR FOR A BRAKE SYSTEM

(71) Applicant: Robert Bosch GmbH, Stuttgart (DE)

(72) Inventors: Benjamin Haufe, Obersulm Willsbach (DE); Konstantin Haberkorn, Stuttgart (DE)

(21) Appl. No.: 18/576,195

(22) PCT Filed: Aug. 8, 2022
(86) PCT No.: PCT/EP2022/072211

§ 371 Date: Jan. 3, 2024

(30) Foreign Application Priority Data
Aug. 19, 2021 (DE) 10 2021 209 093.1

(51) Int. Cl. H02K 5/22; B60T 13/74; F15B 15/18

(52) U.S. Cl. CPC H02K 5/225; B60T 13/745; F15B 15/18

(57) ABSTRACT

A drive device. The drive device includes an electric machine arranged in a housing. The electric machine comprises a rotatably mounted rotor and a stator, which is fixed to the housing and comprises a motor winding, comprising at least one motor phase supply line electrically connected to the motor winding. The motor phase supply line comprises a contact portion, which protrudes from the housing and is electrically connected or connectable to a control device. An insulation element radially surrounds the contact portion at least in sections. The contact portion is integrally formed and the insulation element is slid onto the contact portion.

### FIELD

The present invention relates to a drive device comprising an electric machine arranged in a housing, wherein the electric machine comprises a rotatably mounted rotor and a stator, which is fixed to the housing and comprises a motor winding, in particular a polyphase motor winding, comprising at least one motor phase supply line electrically connected to the motor winding, wherein the motor phase supply line comprises a contact portion, which protrudes from the housing and is electrically connected or connectable to a control device, and comprising an insulation element, which radially surrounds the contact portion at least in sections.

In addition, the present invention relates to a pressure generator for a brake system, with such a drive device.

### BACKGROUND INFORMATION

Some drive devices of the aforementioned type are described in the related art. In a drive device comprising an electric machine, the electric machine is typically arranged in a housing of the drive device. In this case, the machine generally comprises a rotatably mounted rotor and stator, which is fixed to the housing and comprises a motor winding. The motor winding is arranged distributed around the rotor in such a way that the rotor can be rotated by a suitable current feed of the motor winding. Typically, the motor winding is designed to be polyphase. For example, the motor winding has three phases. At least one motor phase supply line is usually provided for electrically contacting the motor winding. The motor phase supply line is electrically connected to the motor winding. In addition, the motor phase supply line comprises a contact portion which protrudes from the housing and is electrically connected or connectable to the control device. An insulation element is often present, which radially surrounds the contact portion at least in sections. The insulation element electrically insulates the contact portion from adjacent metallic components.

In conventional drive devices, the contact portion is typically formed in multiple parts. Specifically, a first contact portion part and a second contact portion part are present, which are fastened to one another by a welded connection. The first contact portion part projects out of the housing of the drive device. The second contact portion part is overmolded with the insulation element and connected or connectable to the control device.

### SUMMARY

A drive device according to the present invention may have an advantage that the costs for the production of the drive device can be reduced. According to an example embodiment of the present invention, it is provided that the contact portion is formed integrally and the insulation element is slid onto the contact portion. The contact portion of the motor phase supply line that protrudes from the housing is thus integrally formed so that a previously provided production step is eliminated, in which a first contact portion part and a second contact portion part are joined together. As a result, costs can be saved. Moreover, the integral design of the contact portion results in the advantage that the risk of resistance increases and contact interruptions is reduced. However, in an integral design of the contact portion, connecting the insulation element by means of overmolding is at least significantly more difficult. According to an example embodiment of the present invention, this is solved in that the insulation element is slid onto the contact portion. The insulation element is thus not produced at or on the contact portion but is already fed as such to the contact portion. In this respect, the insulation element is formed separately from the contact portion. Preferably, the insulation element can be non-destructively detached from the contact portion. Preferably, the insulation element is sleeve-shaped. Preferably, the contact portion projects through a bearing shield or housing cover of the housing and protrudes from the bearing shield. In such a design of the drive device, the separate design of the insulation element furthermore results in advantages in terms of the assembly of the drive device. For example, when the drive device is assembled, the stator is first arranged in a cup-shaped housing part of the housing and electrically connected to the motor phase supply line. The bearing shield is subsequently fastened to the cup-shaped housing part in such a way that the contact portion projects out of the bearing shield and protrudes from the bearing shield. Only then is the insulation element slid or fitted onto the contact portion.

Preferably, the insulation element is designed as an extrusion part. The insulation element is thus produced by means of an extrusion method. This enables cost-efficient production of the insulation element in large quantities.

According to a preferred embodiment of the present invention, it is provided that the insulation element is fastened to a connection plate of the drive device and/or to a bearing shield of the drive device. A connection plate is often used in electric drive devices. It is a component that is arranged in the housing and supports the motor phase supply line. For example, the motor phase supply line is fastened to the connection plate by a latching connection. A bearing shield is also often used in electric drive devices. A bearing shield is a housing cover of the housing that covers the electric machine. Typically, a drive shaft of the drive device is rotatably mounted by the bearing shield. For this purpose, the bearing shield preferably supports a pivot bearing, which acts between the drive shaft and the bearing shield. By fastening the insulation element to the connection plate and/or the bearing shield, mechanically robust fastening of the insulation element can be achieved. Moreover, the connection plate and the bearing shield are easily accessible for the fastening of the insulation element. Preferably, the connection plate comprises an axial protrusion which projects axially through an aperture of the bearing shield and protrudes from the bearing shield, wherein the insulation element is fastened to the axial protrusion. Preferably, the contact portion of the motor phase supply line projects axially through the axial protrusion and protrudes from the axial protrusion. Preferably, the insulation element is fastened to the bearing shield and/or to the connection plate by a latching connection and/or by a frictional connection.

According to a preferred embodiment of the present invention, it is provided that the contact portion is designed as a plug connector. The contact portion is thus electrically connected or connectable to the control device by forming a plug connection. On the one hand, the plug connection provides a mechanically robust, electrical connection between the control device and the contact portion. Moreover, the plug connection can be quickly and technically simply produced by plugging together the contact portion designed as a plug connector and a mating connector of the control device.

According to a preferred embodiment of the present invention, it is provided that at least one end region, assigned to the control device, of the contact portion is silver-plated. On the one hand, silver has a high electrical conductivity. Moreover, silver has a low hardness, which in particular results in advantages in the design of the contact portion as a plug connector. Thus, when the contact portion designed as a plug connector and a mating connector on the control device side are plugged together, the silver is deformed, whereby a large-area contact between the plug connector and the mating connector is achieved.

According to a preferred embodiment of the present invention, it is provided that several motor phase supply lines electrically connected to the motor winding are present, which respectively comprise a contact portion protruding from the housing.

Preferably, a number of motor phase supply lines corresponding to the number of phases is present, wherein each of the motor phase supply lines is electrically connected to a respectively other phase.

Preferably, a number of insulation elements corresponding to the number of motor phase supply lines is present, wherein a respectively other one of the insulation elements is slid onto each of the contact portions. A respectively other one of the insulation elements is thus assigned to each of the contact portions. Such insulation elements can have a structurally simple design. The insulation elements are sleeve-shaped, for example. Due to the simple structural design, the insulation elements can be produced cost-effectively in large quantities.

According to an alternative embodiment of the present invention, it is preferably provided that only one insulation element is present, which radially surrounds the contact portions. The same insulation element is thus assigned to all contact portions. This results in the advantage that the number of components is reduced. Moreover, advantages in terms of the assembly of the drive device and the connection to the control device. With regard to the assembly of the drive device, only a single insulation element rather than several insulation elements must be slid onto the contact portions. The only one insulation element holds the contact portions together, which simplifies the connection of the contact portions to the control device.

Preferably, according to an example embodiment of the present invention, the insulation element comprises a number of apertures corresponding to the number of motor phase supply lines, wherein each of the contact portions projects through a respectively other one of the apertures of the insulation element. The material of the insulation element that separates the apertures from one another electrically insulates the contact portions from one another. According to a further exemplary embodiment of the present invention, the insulation element only comprises one aperture through which the contact portions project. In this exemplary embodiment, a sheath wall of the insulation element that delimits the aperture preferably comprises several bulges by which the contact portions are electrically insulated from one another.

The pressure generator according to the present invention for a brake system comprises a pump device, a drive device for operating the pump device, and a control device for controlling the drive device. The pressure generator with the features of the present invention include the design according to the present invention of the drive device. This also results in the advantages already mentioned. Further preferred features and combinations of features result from what was described above and is further disclosed herein.

According to a preferred embodiment of the present invention, it is provided that the pump device is arranged between the control device and the drive device and that the contact portions of the motor phase supply lines project through a respectively other aperture of a housing of the pump device. In this embodiment, the individual apertures of the housing can be dimensioned to be small so that only a small volume fraction of the housing is needed for the formation of the apertures. In this embodiment of the pressure generator, a number of insulation elements corresponding to the number of motor phase supply lines is preferably present, wherein a respectively other one of the insulation elements is slid onto each of the contact portions.

According to an alternative embodiment of the pressure generator of the present invention, it is preferably provided that the pump device is arranged between the control device and the drive device and that the contact portions of the motor phase supply lines project through the same aperture of the housing of the work machine. This embodiment results in the advantage that only a single aperture for the contact portions must be formed in the housing of the pump device. Accordingly, the number of production steps in the production of the pressure generator is reduced. Only one insulation element which radially surrounds the contact portions is preferably present in this embodiment of the pressure generator. Alternatively, a number of insulation elements corresponding to the number of motor phase supply lines is preferably present, wherein a respectively other one of the insulation elements is slid onto each of the contact portions.

The present invention is explained in more detail below with reference to the figures.

### BRIEF DESCRIPTION OF THE DRAWINGS

FIG. 1 shows a perspective view of a pressure generator for a brake system, according to an example embodiment of the present invention.

FIG. 2 shows a cross-sectional view of a drive device of the pressure generator, according to an example embodiment of the present invention.

FIG. 3 shows a perspective of a drive device, according to an example embodiment of the present invention.

### DETAILED DESCRIPTION OF EXAMPLE EMBODIMENTS

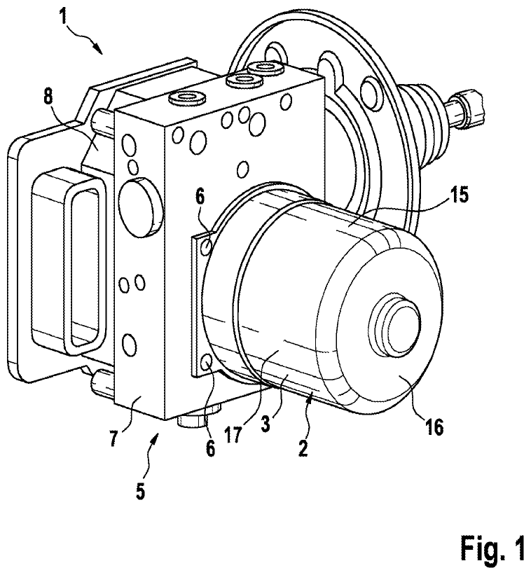

FIG. 1 shows a perspective view of a pressure generator 1 for a hydraulic brake system of a motor vehicle. The pressure generator 1 comprises an electric drive device 2. The drive device 2 comprises a housing 3, which in the present case has a circular cross section. In addition, the drive device 2 comprises an electric machine 4. The electric machine 4 is arranged in the housing 3 and therefore cannot be seen in FIG. 1. As a work machine, the pressure generator 1 comprises a pump device 5 with at least one fluid pump. The housing 3 of the drive device 2 is fastened to a housing 7 of the pump device 5 by several fastening means 6. The drive device 2 is designed to operate the at least one fluid pump of the pump device 5 by means of the electric machine 4. In addition, the pressure generator 1 comprises a control device 8 for controlling the electric machine 4. The pump device 5 is arranged between the drive device 2 on the one hand and the control device 8 on the other hand.

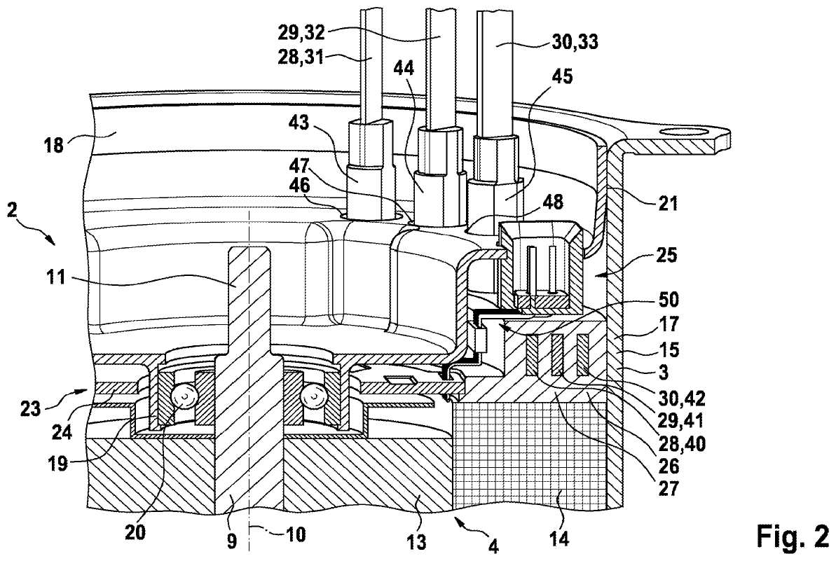

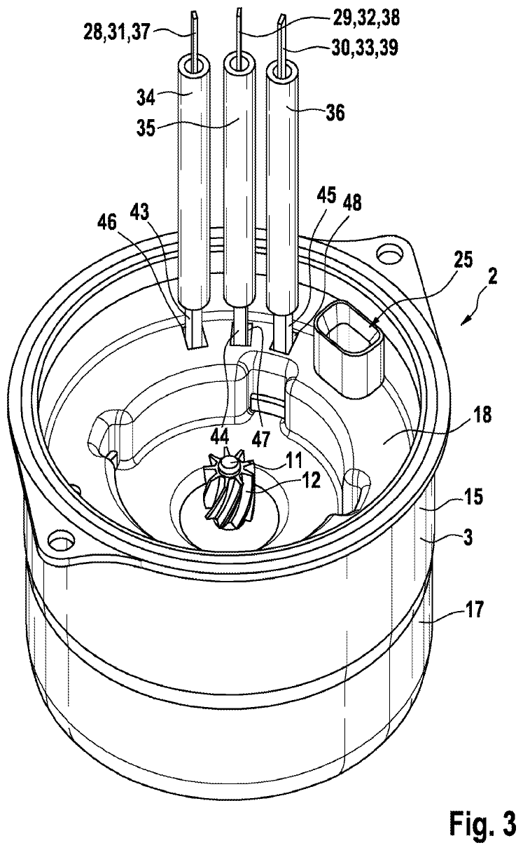

The following explains the design of the drive device 2 in more detail. For this purpose, FIG. 2 shows a sectional view of the drive device 2. FIG. 3 shows a perspective view of the drive device 2.

As can be seen in FIG. 2, the drive device 2 comprises a drive shaft 9, which is rotatably mounted in the housing 3 about an axis of rotation 10. An end portion 11 of the drive shaft 9 projects out of the housing 3. On the end portion 11, a spur gear 12, which can be seen in FIG. 3, is arranged in a rotationally fixed manner. If the drive device 2 is installed in the pressure generator 1 as shown in FIG. 1, the spur gear 12 is part of a gear device by which the drive shaft 9 is operatively connected to the at least one fluid pump of the pump device 5.

The electric machine 4 comprises a rotor 13 arranged in a rotationally fixed manner on the drive shaft 9. The axis of rotation of the rotor 13 corresponds to the axis of rotation 10 of the drive shaft 9. The electric machine 4 also comprises a stator 14 arranged fixed to the housing. The stator 14 has a polyphase motor winding, which is not shown for reasons of clarity and is arranged distributed around the rotor 13 in such a way that the rotor 13 and thus the drive shaft 9 can be rotated or driven by a suitable current feed of the motor winding. In the present case, the motor winding has three phases.

The housing 3 comprises a housing part 15, which supports the stator 14. The housing part 15 is produced from a metal material. As can be seen in FIG. 1, the housing part 15 is cup-shaped. In this respect, the housing part 15 has a bottom 16 and a sleeve portion 17. The bottom 16 extends at least substantially in the radial direction. Starting from the bottom 16, the sleeve portion 17 extends at least substantially in the axial direction. The housing 3 also comprises a bearing shield 18. The bearing shield 18 covers the electric machine 4 and in this respect forms a housing cover of the housing 3. The bearing shield 18 is designed for mounting the drive shaft 9. For this purpose, the bearing shield 18 comprises a sleeve-shaped bearing portion 19 which extends in the axial direction. A pivot bearing 20, which in the present case is a rolling body bearing 20, is arranged between the bearing portion 19 and the drive shaft 9. The bearing shield 18 also comprises a sleeve-shaped fastening portion 21 which extends in the axial direction. The fastening portion 21 fastens the bearing shield 18 to the housing part 15, for example by a frictional connection, by an adhesive connection, by a welded connection, and/or by at least one fastening means.

The drive device 2 also comprises a sensor unit 23 which is arranged fixed to the housing and is designed to sense a rotational position of the rotor 13. For this purpose, the sensor unit 23 comprises an annular circuit board 24 with a sensor element, which cannot be seen. The sensor unit 23 also comprises a connection device 25, by which the sensor unit 23 is electrically connected or connectable to the control device 8.

The circuit board 24 is electrically connected to the connection device 25 by a contact unit 50.

The drive device 2 also comprises a number of electrically conductive motor phase supply lines 28, 29 and 30 corresponding to the number of phases of the motor winding. The motor phase supply lines 28, 29 and 30 are electrically connected to a respectively other phase of the motor winding of the stator 14. In addition, the motor phase supply lines 28, 29 and 30 are respectively electrically connected or connectable to the control device 8.

The motor phase supply lines 28, 29 and 30 respectively comprise an elongate contact portion 31, 32 or 33, which protrudes from the housing 3. The motor phase supply lines 28, 29 and 30 are electrically connected or connectable to the control device 8 by the contact portions 31, 32 and 33. The contact portions 31, 32 and 33 are integrally formed. The contact portions 31, 32 and 33 thus consist of only one part and not of several assembled parts.

As can be seen in FIG. 3, a respectively other insulation element 34, 35 or 36 is slid onto contact portions 31, 32 and 33. The insulation elements 34, 35 and 36 can thus be handled separately from the contact portions 31, 32 and 33. FIG. 2 does not show the insulation elements 34, 35 and 36. The insulation elements 34, 35 and 36 are, for example, formed as extrusion parts. In the present case, the insulation elements 34, 35 and 36 are sleeve-shaped. The insulation elements 34, 35 and 36 radially surround a portion of the contact portions 31, 32 and 33. If the drive device 2 is installed in the pressure generator 1 as shown in FIG. 1, the contact portions 31, 32 and 33 project axially through the housing 7 of the pump device 5. In this case, the contact portions 31, 32 and 33 are electrically insulated from the housing 7 by the insulation elements 34, 35 and 36. Preferably, the housing 7 of the pump device 5 comprises a number of apertures corresponding to the number of contact elements 31, 32 and 33, wherein one of the contact elements 31, 32 and 33 respectively projects through each of the apertures of the housing 7. Alternatively, the housing 7 preferably has only one aperture through which the contact elements 31, 32 and 33 project.

According to a further exemplary embodiment, instead of the insulation elements 34, 35 and 36, the drive device 2 comprises only a single insulation element, which radially surrounds the contact portions 31, 32 and 33. For example, this insulation element has one of the number of contact portions 31, 32 and 33 corresponding to each of the number of apertures, each of the contact portions 31, 32 and 33 project through a respectively different one of the apertures of the insulation element. In this exemplary embodiment, the housing 7 of the pump device 5 has only one aperture through which the contact portions 31, 32 and 33 project.

As can be seen in FIG. 3, the contact portions 31, 32 and 33 respectively comprise an end region 37, 38 or 39, which projects out of the respective insulation element 34, 35 or 36. The contact portions 31, 32 and 33 are electrically connected or connectable to the control device 8 by the end regions 37, 38 and 39. In the present case, the contact portions 31, 32 and 33 are designed as plug connectors 31, 32 and 33. The contact portions 31, 32 and 33 are thus electrically connected or connectable to the control device 8 by plugging them and mating connectors on the control device side together. In the present case, at least the end regions 37, 38 and 39 of the contact portions 31, 32 and 33 are silver-plated.

The drive device 2 also comprises a connection plate 26, which is arranged, fixed to the housing, in the housing 3. In the present case, the connection plate 26 is annular and is arranged axially adjacent to the stator 14 in such a way that the connection plate 26 covers the stator 14. The connection plate 26 comprises a base body 27 made of an insulating material, such as a plastic. The motor phase supply lines 28, 29 and 30 respectively comprise an annular portion 40, 41 or 42. The annular portions 40, 41 and 42 extend through the connection plate 26 and are fastened to the connection plate 26, for example by a latching connection in each case. The annular portions 40, 41 and 42 electrically connect the motor phase supply lines 28, 29 and 30 to the phases of the motor winding, for example by means of at least one insulation displacement termination connection in each case. Preferably, the contact portions 31, 32 and 33 are integrally formed with the annular portions 40, 41 and 42. Particularly preferably, the motor phase supply lines 28, 29 and 30 are respectively designed overall as a stamped-bent part.

As can be seen in FIG. 2, the connection plate 26 comprises a number of axial protrusions 43, 44 and 45 corresponding to the number of motor phase supply lines 28, 29 and 30. The bearing shield 18 has a number of apertures 46, 47 and 48 corresponding to the number of axial protrusions 43, 44 and 45, wherein each of the axial protrusions 43, 44 and 45 axially projects through a respectively other one of the apertures 46, 47 and 48. The contact portions 31, 32 and 33 project axially through a respectively other one of the axial protrusions 43, 44 and 45.

The axial protrusions 43, 44 and 45 electrically insulate the contact portions 31, 32 and 33 from the bearing shield 18. In the drive device shown in FIG. 2, the axial protrusions 43, 44 and 45 as well as the apertures 46, 47 and 48 respectively have a circular cross section. The drive device 2 shown in FIG. 3 deviates therefrom in that the axial protrusions 43, 44 and 45 as well as the apertures 46, 47 and 48 respectively have a rectangular cross section. The insulation elements 34, 35 and 36 are fastened to the axial protrusions 43, 44 and 45, for example by a frictional connection. Alternatively, the insulation elements 34, 35 and 36 are fastened to the bearing shield 18, for example.

The procedure for the assembly of the drive device 2 is preferably as follows. The stator 14 is installed in the housing part 15. The motor phase supply lines 28, 29 and 30 are fastened to the connection plate 26 in such a way that the contact portions 31, 32 and 33 project through the axial protrusions 43, 44 and 45. The connection plate 26 is subsequently installed with the motor phase supply lines 28, 29 and 30 in the housing part 15, wherein the motor phase supply lines 28, 29 and 30 are electrically connected to the motor winding of the stator 14. Thereafter, the bearing shield 18 is mounted in such a way that the contact portions 31, 32 and 33 as well as the axial protrusions 43, 44 and 45 project axially through the apertures 46, 47 and 48. The insulation elements 34, 35 and 36 are subsequently slid onto the contact portions 31, 32 and 33 protruding from the bearing shield 18 of the housing 3.

1-12. (canceled)

13. A drive device, comprising:
an electric machine arranged in a housing, the electric machine including a rotatably mounted rotor, and a stator which is fixed to the housing and includes a polyphase motor winding, at least one motor phase supply line being electrically connected to the motor winding, wherein the motor phase supply line includes a contact portion which protrudes from the housing and is electrically connected or connectable to a control device, and an insulation element radially surrounds the contact portion at least in sections;
wherein the contact portion is integrally formed and the insulation element is slid onto the contact portion.

14. The drive device according to claim 13, wherein the insulation element is configured as an extrusion part.

15. The drive device according to claim 13, wherein the insulation element is fastened to a connection plate of the drive device and/or to a bearing shield of the drive device, by a latching connection and/or by a frictional connection.

16. The drive device according to claim 13, wherein the contact portion is a plug connector.

17. The drive device according to claim 13, wherein at least one end region of the contact portion, assigned to the control device, is silver-plated.

18. The drive device according to claim 13, wherein several motor phase supply lines electrically connected to the motor winding are present, which each respectively includes a contact portion protruding from the housing.

19. The drive device according to claim 18, wherein a number of insulation elements corresponding to a number of the motor phase supply lines is present, wherein a respective insulation element is slid onto each of the contact portions.

20. The drive device according to claim 18, wherein only one insulation element is present, which radially surrounds the contact portions.

21. The drive device according to claim 20, wherein the insulation element includes a number of apertures corresponding to the number of motor phase supply lines wherein each of the contact portions projects through a respective different one of the apertures of the insulation element.

22. A pressure generator for a brake system, comprising:
a pump device;
a drive device configured to operate the pump device; and
a control device configured to control the drive device;
wherein the drive device includes:
an electric machine arranged in a housing, the electric machine including a rotatably mounted rotor, and a stator which is fixed to the housing and includes a polyphase motor winding, at least one motor phase supply line being electrically connected to the motor winding, wherein the motor phase supply line includes a contact portion which protrudes from the housing and is electrically connected or connectable to the control device, and an insulation element radially surrounds the contact portion at least in sections;
wherein the contact portion is integrally formed and the insulation element is slid onto the contact portion.

23. The pressure generator according to claim 22, wherein the pump device is arranged between the control device and the drive device, wherein several motor phase supply lines electrically connected to the motor winding are present in the drive device, which each respectively includes a contact portion protruding from the housing, and wherein the contact portions of the motor phase supply lines project through a respective different apertures of a housing of the pump device.

24. The pressure generator according to claim 22, wherein the pump device is arranged between the control device and the drive device, wherein several motor phase supply lines electrically connected to the motor winding are present in the drive device, which each respectively includes a contact portion protruding from the housing, and wherein the contact portions of the motor phase supply lines project through the same aperture of a housing of the pump device.
